(19) United States
(12) Patent Application Publication
(10) Pub. No.: US 2018/0183040 A1
(43) Pub. Date: Jun. 28, 2018

(54) ELECTROCHEMICAL DEVICE INCLUDING THREE-DIMENSIONAL ELECTRODE SUBSTRATE

(71) Applicants: THE REGENTS OF THE UNIVERSITY OF MICHIGAN, ANN ARBOR, MI (US); BATTERY NANO TECHNOLOGIES, INC., Shelby Township, MI (US)

(72) Inventor: BINAY PRASAD, Shelby Township, MI (US)

(21) Appl. No.: 15/757,117

(22) PCT Filed: Sep. 2, 2016
(86) PCT No.: PCT/US16/50053

§ 371 Date: Mar. 2, 2018

Related U.S. Application Data
(60) Provisional application No. 62/213,470, filed on Sep. 2, 2015.

(51) Int. Cl. H01M 4/131; H01G 11/26; H01G 11/50; H01G 11/46; H01G 11/86; H01G 11/06; H01M 4/525; H01M 4/62; H01M 4/66; H01M 4/80; H01M 10/0525; H01M 4/1391; H01M 4/04; G01N 27/30

(52) U.S. Cl. CPC H01M 4/131; H01M 2004/028; H01G 11/50; H01G 11/46; H01G 11/86; H01G 11/06; H01M 4/525; H01M 4/624; H01M 4/623; H01M 4/661; H01M 4/808; H01M 4/803; H01M 4/801; H01M 10/0525; H01M 4/1391; H01M 4/0404; H01M 4/049; G01N 27/30; H01G 11/26

(57) ABSTRACT

An electrode includes a porous metallic substrate and a conductive electrode material disposed on the porous metallic substrate. The conductive electrode material includes an active material comprising an alkali metal compound providing an alkali metal ion for an electrochemical reaction and a conductive agent comprising cobalt oxyhydroxide. This electrode may be used in the construction of electrochemical devices such as lithium-ion batteries, capacitors, and sensor.

### CROSS-REFERENCE TO RELATED APPLICATION

This application claims priority from U.S. Patent Application No. 62/213,470 filed Sep. 2, 2015.

### STATEMENT OF FEDERALLY SPONSORED RESEARCH OR DEVELOPMENT

Not applicable.

### TECHNICAL FIELD

This invention relates to an electrochemical device with enhanced utilization in which the electrochemical device has a three-dimensional substrate and a substantially carbonless conductive agent.

### BACKGROUND

Lithium-ion batteries are widely used as a portable source of electricity, for example, in consumer electronic devices, industrial applications, and electric vehicles.

A lithium-ion battery typically involves an anode and a cathode and an electrolyte. The cathode may use a variety of active materials (such as, for example, Lithium Cobalt Oxide, composite Lithium Oxides, Lithium Iron Phosphate, and so forth). The anode may be made from lithium metal; however, lithiated graphite is the standard and provides essentially the same voltage and performance as lithium metal. The electrolyte is generally 1 M lithium hexafluorophosphate (LiPF₆). A separator is used to insulate the adjacent anode and cathode from each other (preventing shorts), and a cell compartment houses the anode, cathode, electrolyte, and separator.

During discharge of the battery to produce electricity, lithium ions are electrochemically drawn from the anode of the battery to the cathode of the battery and which provides an electric current between the terminals of the battery to power a device to which the battery is attached.

### SUMMARY

Current cathode technology for lithium-ion batteries only shows a utilization rate of 40 to 50 percent. This means that more than half of the active energy is wasted.

Herein, a modified electrode construction is disclosed that provides greatly improved utilization rates near 80 to 90 percent as a consequence of the synergy obtained by using its new carbonless conductor and higher conducting foam substrate. Apart from this dramatic improvement in battery performance, the removal of carbon reduces the probability of combustion of the battery.

More specifically, the utilization rates are improved by changing the conductor used in the cathode from the traditional carbon to cobalt oxyhydroxide. Cobalt oxyhydroxide is significantly less flammable than traditional carbon. When this new electrode material is used in conjunction with a three-dimensional, porous substrate to replace traditional two-dimensional planar foils, these immense gains in utilization can be realized. These porous substrates may be, for example, metal foams or formed from bonded metal filaments and provide increased amounts of surface area between the paste and the substrate.

Initial tests show very consistent and high utilization levels near 80 to 90 percent. Currently, the test batteries experience this improvement in the 1.3V-2V range. However, initial experiments have been performed using nickel foam. It is expected that this range can be increased to the operating voltage of consumer electronics (2.25V-2.5V) and that material modifications such as, for example, switching from a nickel foam substrate to an aluminum foam (aluminum being three times more conductive than nickel) and/or adding additional conductive metal elements to the paste, can largely address this voltage issue.

According to one aspect, an electrode is provided having a porous metallic substrate and a conductive electrode material received on the porous metallic substrate. The conductive electrode material includes an active material comprising an alkali metal compound providing an alkali metal ion for an electrochemical reaction and a conductive agent comprising cobalt oxyhydroxide. The electrode may be a cathode.

In one version of the electrode, the active material is selected from the group consisting of lithium cobalt oxide, lithium iron phosphate, lithium manganese oxide, lithium nickel manganese cobalt oxide, lithium nickel cobalt aluminum oxide, lithium titanate, lithium vanadium oxide, lithium iron fluorophosphates, sodium iron phosphate, sodium iron fluorophosphates, sodium vanadium fluorophosphates, sodium vanadium chromium fluorophosphates, sodium hexacyanometallates, potassium hexacyanometallates, and lithium-containing layered compounds having hexagonal symmetry based on α-NaFeO2 structure with a space group of R3-m. In another version of the electrode, the active material is lithium cobalt oxide.

In one version of the electrode, at least some cobalt in the cobalt oxyhydroxide of the conductive agent has a +4 oxidation state. In another version of the electrode, at least some cobalt in the cobalt oxyhydroxide of the conductive agent has a +3 oxidation state.

In one version of the electrode, the porous metallic substrate comprises a porous aluminum material. In another version of the electrode, the porous metallic substrate comprises a porous nickel material. In another version of the electrode, the substrate comprises a metal selected from aluminum, copper, silver, iron, zinc, nickel, titanium, and gold. In another version of the electrode, the porous metallic substrate is composed of a foam. In another version of the electrode, the porous metallic substrate is composed of a plurality of bonded fibers.

In one version of the electrode, the electrode material penetrates into the porous metallic substrate thereby providing a greater loading surface area in comparison to a flat non-porous substrate. In another version of the electrode, the conductive electrode material contains no carbon. In another version of the electrode, the conductive electrode material further comprises polyvinylidene fluoride as a binder.

In one version of the electrode, the conductive electrode material further includes an additive in the form of a metallic powder. The metallic powder may be an aluminum powder.

According to another aspect, an electrochemical device is provided including an electrode of the type recited herein as a positive electrode, a negative electrode, and a non-aqueous electrolyte. In one version of the electrochemical device, the negative electrode comprises a negative electrode active material selected from the group consisting of lithium metal, graphite, lithium metal oxides, hard carbon, tin/cobalt alloy, and silicon/carbon. The electrochemical device may be a lithium-ion battery. The electrochemical device may be a capacitor. The electrochemical device may be a sensor.

According to yet another aspect, a method for producing an electrode is provided. The method includes applying a conductive paste to a porous metallic substrate in which the conductive paste includes an active material comprising an alkali metal compound providing an alkali metal ion for an electrochemical reaction and a conductive agent comprising cobalt hydroxide. This cobalt hydroxide may be oxidized to form cobalt oxyhydroxide.

The method may further comprise the step of: oxidizing the cobalt hydroxide to form cobalt oxyhydroxide. In the method, at least some cobalt in the cobalt oxyhydroxide can have a +3 oxidation state and at least some cobalt in the cobalt oxyhydroxide can have a +4 oxidation state.

These and still other advantages of the invention will be apparent from the detailed description and drawings. What follows is merely a description of some preferred embodiments of the present invention. To assess the full scope of the invention, the claims should be looked to as these preferred embodiments are not intended to be the only embodiments within the scope of the claims.

### BRIEF DESCRIPTION OF THE FIGURES

FIG. 1 is a graph showing the discharge curve of an electrochemical device employing a porous nickel substrate with an improved conductive paste further including aluminum powder additions to enhance conductivity in accordance with test number 1 of the Example.

FIGS. 2A and 2B are graphs showing a representative discharge curve for two electrochemical devices employing a porous nickel substrate with an improved conductive paste in accordance with test numbers 2 though 6 of the Example.

FIGS. 3A through 3C are graphs showing the discharge curve over various hour durations for an electrochemical device employing a porous nickel substrate with an improved conductive paste in accordance with test number 7 of the Example.

### DETAILED DESCRIPTION

Disclosed herein is an electrode, an electrochemical device incorporating this electrode, and related method of making the electrode. Another application including the same inventor which expressly discloses ways of making a carbon-less conductive paste is entitled “Electrochemical Device Electrode Including Cobalt Oxyhydroxide” and was filed as U.S. patent application Ser. No. 14/308,019 on Jun. 18, 2014 and published as U.S. Patent Application Publication No. 2015/0017544 on Jan. 15, 2015; this published application is incorporated by reference as if set forth in its entirety herein for all purposes.

Herein, a method of significantly improving active material utilization in lithium-ion batteries and a host of electrochemical devices is provided (including, for example, capacitors, sensors, semiconductor electrodes, and so forth). This improvement can be obtained by using an electrochemically controllable and dynamically adjustable electronic conducting agent (that is, cobalt hydroxide or, after oxidation, cobalt oxyhydroxide) in the electrode material in conjunction with a porous substrate. Thus, this disclosure offers a way to produce beneficiary effects within a lithium-ion battery by controlling the electrochemical environment in the presence of a new electronic conductor within the cathode material.

Additionally, a significant reduction of internal resistance can be achieved by enhancing active material utilization either in situ or in a separate conditioning cell in a glove box with complete Argon cover. Thus, the in situ conditioning will be done in a finished cell like a coin cell. The treatment done in the conditioning cell can be without constructing the full battery first, and after the cathode conditioning is complete, a complete battery may be subsequently made. When a significant reduction in the internal resistance of the cathode is obtained, this allows very high levels of active material utilization numbers to be achieved. Using the improved paste and substrate described herein can result in increases in the utilization levels reached to 90% from a low 40% utilization observed in the state of the art batteries.

This advantage is largely derived because of the use of an electronic conductor like cobalt hydroxide and/or cobalt oxyhydroxide instead of carbon in the cathode paste such that the improved conductive electrode material is a dynamic conductor rather than merely being a static conductor. This improved electronic conductor is capable of being worked inside the cathode to produce variable degrees of conductivity depending upon the electrochemical environment selected. Thus, it becomes a variable conductor rather than a static one. The presently-used, conventional conductor in most conductive electrode materials is carbon and carbon can only produce a fixed amount of conductivity. As such, the carbon based pastes might be referred to as a static conductor.

The manner in which the improved cathode operates is somewhat analogous to doping in semiconductors. Doping is used in semiconductors to improve their conductivity when part per million levels of a dopant is added to an insulator (like silicon). The band gap of the semiconductor is reduced considerably, thus rendering an insulator significantly more conducting. In the case of silicon, silicon can be doped as a p-type or an n-type semiconductor by selecting the dopant.

In case of the improved conductive paste, cobalt hydroxide can be oxidized to form cobalt oxyhydroxide to result in the creation of +3 and +4 oxidation states over the base +2 causes improvement of conductivity. The amount of +2/+3 state is controllable by electrochemical means.

Thus, according to one aspect, an electrode can be constructed having a porous metallic substrate and a conductive electrode material received on the porous metallic substrate. The conductive paste includes an active material comprising an alkali metal compound providing an alkali metal ion for an electrochemical reaction and a conductive agent comprising cobalt oxyhydroxide.

It is contemplated that an electrode of this type may serve as a cathode. While particularly synergistic benefits may be obtained using this improved conductive electrode material on a three-dimensional porous substrate with an intricate structure (to increase the surface area), it is contemplated that this improved paste might also be used on flat foil substrates.

In some forms of the electrode, the active material may be selected from the group consisting of lithium cobalt oxide, lithium iron phosphate, lithium manganese oxide, lithium nickel manganese cobalt oxide, lithium nickel cobalt aluminum oxide, lithium titanate, lithium vanadium oxide, lithium iron fluorophosphates, sodium iron phosphate, sodium iron fluorophosphates, sodium vanadium fluorophosphates, sodium vanadium chromium fluorophosphates, sodium hexacyanometallates, potassium hexacyanometallates, and lithium-containing layered compounds having hexagonal symmetry based on α-NaFeO₂ structure with a space group of R3-m.

In some forms of the electrode, at least some cobalt in the cobalt oxyhydroxide of the conductive agent may have a +4 oxidation state and/or at least some cobalt in the cobalt oxyhydroxide of the conductive agent has a +3 oxidation state.

In some forms of the electrode, the porous metallic substrate may comprise a porous aluminum material or a porous nickel material. It is contemplated that, in some forms, the porous metallic substrate may be composed of a foam or may be composed of a plurality of bonded fibers. The substrate may comprise a metal selected from aluminum, copper, silver, iron, zinc, nickel, titanium, and gold. The electrode material may penetrate into the porous metallic substrate thereby providing a greater loading surface area in comparison to a flat non-porous substrate. The use of metallic porous structures offers some additional and marginal improvements over the current state of the art current collectors, in part, because the porous material offers a greater interface with the improved conductive past that can be fully utilized.

As yet another example of a potential contemplated structure, metallic foam (for example, an aluminum foam) may be obtained from Sumitomo Metal Foam Technology and used in conjunction with the improved conductive paste to control the internal resistance of the battery in a dynamic manner.

With respect to the improved conductive electrode material, as noted above, the conductive electrode material may contain no carbon.

However, the electrode material can include more than just the active material and the cobalt oxyhydroxide. The conductive electrode material may further comprise polyvinylidene fluoride as a binder. In some forms, it is contemplated that the conductive electrode material may further include an additive in the form of a metallic powder (for example, an aluminum powder), which can further alter the conductive properties of the electrode.

It is further noted that cobalt hydroxide can be placed initially in the paste and finally formed into cobalt oxyhydroxide by an oxidation step such as is described in U.S. Patent Application Publication No. 2015/0017544, which was incorporated by reference above.

Various combinations of the features recited are contemplated as being workable within a single electrode. For example, it will be appreciated that the use of polyvinylidene fluoride as a binder could be combined with a metallic powder additive in the making of a paste that is formed into the electrode material.

According to another aspect, an electrochemical device is provided including an electrode of the type recited above as a positive electrode, a negative electrode, and a non-aqueous electrolyte.

It will be appreciated that the various features described above with respect to the electrode (for example, additional materials in the paste, materials of the substrate, and so forth) could be implemented in the electrode of this electrochemical device in various workable combinations with one another.

In some forms of the electrochemical device, the negative electrode may comprise a negative electrode active material selected from lithium metal and alloys of lithium.

The electrochemical device may be any one of a number of electrochemical devices including, but not limited to, a lithium-ion battery, a capacitor, and a sensor.

According to still another aspect, a method for producing an electrode is provided. The method includes applying a conductive paste to a porous metallic substrate in which the conductive paste includes an active material comprising an alkali metal compound providing an alkali metal ion for an electrochemical reaction and a conductive agent comprising cobalt hydroxide.

The method may further include the step of oxidizing the cobalt hydroxide to form cobalt oxyhydroxide.

The electrode made using this method can have at least some cobalt in the cobalt oxyhydroxide with a +3 oxidation state and at least some cobalt in the cobalt oxyhydroxide with a +4 oxidation state.

In some forms, the electrochemical conditions may be enhanced using the foam structure in new and different cells by varying the amounts of the electronic conductor (such as cobalt hydroxide added). It is contemplated that the amount of cobalt hydroxide might be added in an amount between 0 to 30 wt %. Additionally the electrochemical conditions might be further enhanced by varying the amounts of active materials used and their types or by using active materials in various combinations with one another.

It is further contemplated that changes in the concentration and types of the electrolytes used both in situ and in conditioning cells can be used to alter electrochemical conditions or that different anodes (like lithium titanate, graphite, lithium silicon oxides, and so forth) may be used.

Still yet, it is contemplated that different voltage treating conditions during charge and discharge may be utilized to alter and further enhance the electrochemical conditions.

Still yet, various different cell formation methods may be employed to alter the electrochemical conditions. For example, a low rate charge, a mixed low/high rate conditioning or a final return to charge and discharge conditions may be employed.

It is contemplated that the cobalt hydroxide or cobalt oxyhydroxide can penetrate the active material by electrochemical treatments. This penetration can be either at the surface or within the active material (lithium cobalt oxide). In case of surface access, it is called surface coating and when the bulk is penetrated it is called doping.

Specific examples are provided below showing the performance of various prepared test samples. These examples are offered for illustrative purposes only, and are not intended to limit the scope of the present invention in any way. Indeed, various modifications of the invention in addition to those shown and described herein will become apparent to those skilled in the art from the foregoing description and the following examples and fall within the scope of the appended claims.

### EXAMPLE 1

Seven test samples were prepared. All seven of the test samples were prepared on a continuous nickel foam substrate which was obtained from Dalian Thrive Metallurgy Import & Export Co., Ltd. of Liaoning, China. The nickel foam substrate had a 99.5% porosity having 110 pores per inch, a 1.6 mm thickness and a 200 mm width. Typically, these samples are provided on long rolls (typically 167 m per roll) and may be cut to the desired length.

The conductive paste was applied to the surface of the nickel foam substrate such that the paste penetrated into and substantially filled the pores. In all test samples, except for test sample 1, the conductive cathode paste composition used is 5 wt % cobalt hydroxide, 5 wt % binder (polyvinylidene fluoride, PvDF), and 90 wt % lithium cobalt oxide. The conductive cathode paste composition in test sample 1 varied slightly in that it also included aluminum powder such that the composition of the paste was 10 wt % cobalt hydroxide, 10 wt % binder (polyvinylidene fluoride, PvDF), 5 wt % aluminum powder with the remainder being lithium cobalt oxide. The aluminum powder was obtained from Rocket City Chemical, Inc. of Huntsville, Ala. and is 99.9% pure, having a particle size between 300 microns to 500 mesh. The addition of aluminum powder was added to improve conduction, since the aluminum powder conducts in addition to the cobalt hydroxide.

As can be seen in Table 1 below, which provides the various test conditions, the various samples were all charged at 8×10⁻⁴ Amps to 4.2 volts and discharged at 4×10⁻⁸ Amps (in the case of test numbers and samples 1 and 7) or 4×10⁻⁸ Amps (in the case of test numbers and samples 2 through 6) toward a 1 volt cut off. The seven tests being run on the samples below are:

TABLE 1

| | | | | Improvement | | Number | |
|---|---|---|---|---|---|---|---|
| | Charge | Discharge | Expected | over | | of hours | Cut off |
| Test | current | current | capacity | standard | Voltage | run | voltage |
| number | (A) | (A) | (mA) | (%) | (V) | (h) | (V) |
| 1 | 8 × 10⁻⁴ | 4 × 10⁻⁸ | 5 | Continuing | 1.8 | 1100 | 1 |
| | | | | to run | | | |
| 2 | 8 × 10⁻⁴ | 4 × 10⁻⁶ | 10 | over 50% | 1.25 | 625 | 1 |
| 3 | 8 × 10⁻⁴ | 4 × 10⁻⁶ | 10 | over 50% | 1.25 | 625 | 1 |
| 4 | 8 × 10⁻⁴ | 4 × 10⁻⁶ | 10 | over 50% | 1.23 | 625 | 1 |
| 5 | 8 × 10⁻⁴ | 4 × 10⁻⁶ | 10 | over 50% | 1.3 | 625 | 1 |
| 6 | 8 × 10⁻⁴ | 4 × 10⁻⁶ | 10 | over 50% | 1.27 | 625 | 1 |
| 7 | 8 × 10⁻⁴ | 4 × 10⁻⁸ | 4 | over 50% | 1.98 | 1250 | 1 |

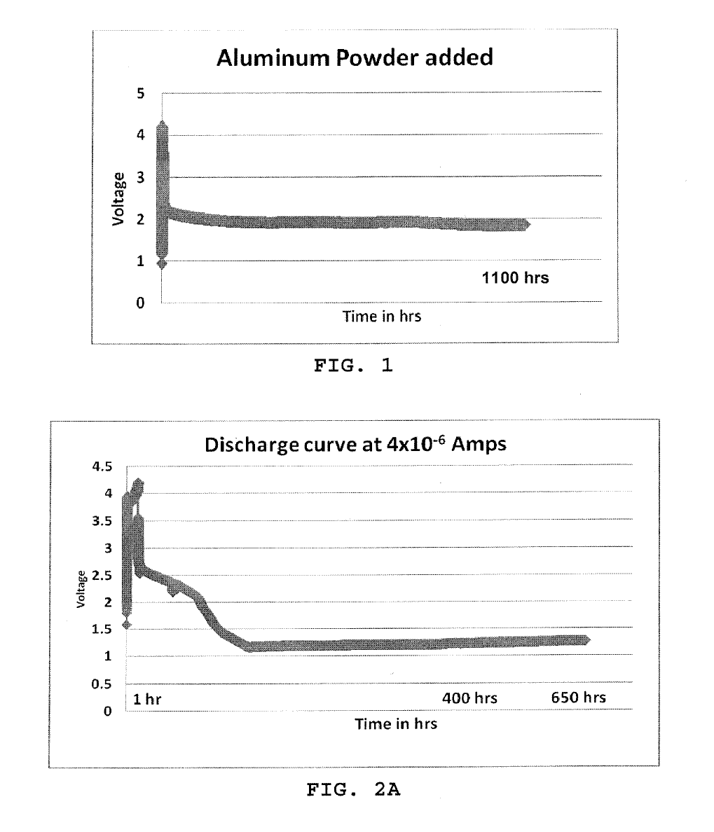

Referring now to FIG. 1, the discharge curve for test number 1 is provided. It can be seen that after 1100 hours of discharge, the voltage remains just below 2 Volts at approximately 1.8 V, where it has remained for approximately the last 1000 hours. It is observed that the discharge curve remains very consistent (that is, of nearly constant voltage over time) in comparison to the other samples, which may be attributed both the slower rate of discharge and the use of aluminum powder in this sample which enhances conductivity.

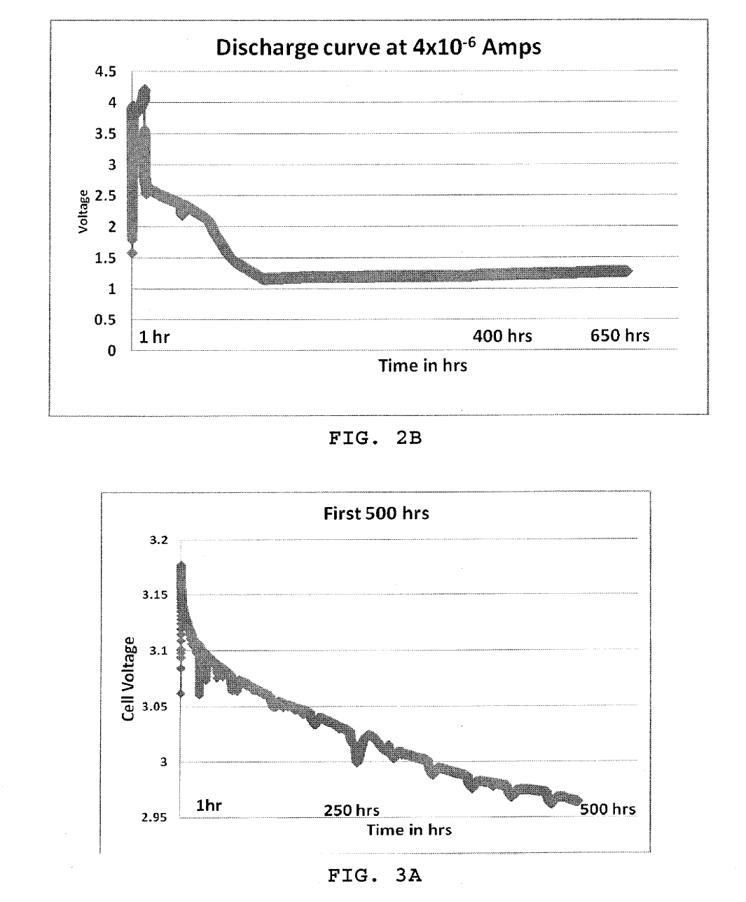

FIGS. 2A and 2B provide representative discharge curves for test numbers 2 through 6 which have shown very uniform behavior with one another. This uniformity can be discerned from the similar voltage that each exhibit after 625 hours of discharge in Table 1. It is noted that the discharge curve involves a slight drop and then rise in voltage, which may be attributable to conditioning of the cathode over time.

It should be appreciated that the voltage is relatively low compared to the voltages that would be required for use in commercial electronics. However, the voltage may be potentially adjusted upwards, as described above, by replacing the porous nickel substrate with a porous aluminum substrate (which should have approximately three times the conductivity of the nickel substrate) and/or by adding additional conductive powders to the conductive paste (such as the aluminum powder used in test sample 1). Therefore, by engineering adjustments, it is contemplated that a more commercially desirable voltage might be achieved.

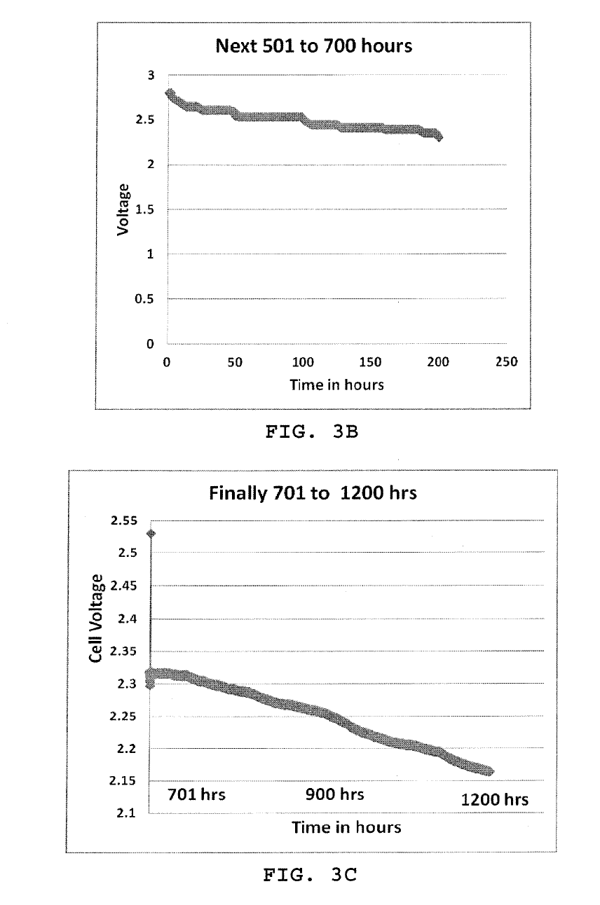

Referring now to FIGS. 3A through 3C, a discharge curve over various time intervals for test number 7 is illustrated. The separate graphs are used because each chart only covers a partial duration of the trial. FIG. 3A illustrates the first 500 hours, FIG. 3B illustrates hours 501 to 700, and FIG. 3C illustrates hours 701 onward to 1200.

These tests already represent significant improvements in utilization over cathodes prepared by pasting a carbon-containing paste on a standard two-dimension, thin foil.

### EXAMPLE 2

Materials of aluminum and copper foams as substrates are currently being examined. The objective is to duplicate the density and porosity in aluminum and copper foams to match that on nickel foam. The nickel foam was of 0.92 gm per cc. The samples we have obtained in aluminum and copper foam are 0.14 and 0.2 gm per cc. They are considerably less but do show a higher voltage during discharge initially for copper foam. These tests are still being run. Efforts are on to obtain equivalent aluminum and copper foams.

It should be appreciated that various other modifications and variations to the preferred embodiments can be made within the spirit and scope of the invention. Therefore, the invention should not be limited to the described embodiments. To ascertain the full scope of the invention, the following claims should be referenced.

What is claimed is:

1. An electrode comprising:
a porous metallic substrate; and
a conductive electrode material disposed on the porous metallic substrate, the conductive electrode material including:
an active material comprising an alkali metal compound providing an alkali metal ion for an electrochemical reaction; and
a conductive agent comprising cobalt oxyhydroxide.

2. The electrode of claim 1 wherein:
the active material is selected from the group consisting of lithium cobalt oxide, lithium iron phosphate, lithium manganese oxide, lithium nickel manganese cobalt oxide, lithium nickel cobalt aluminum oxide, lithium titanate, lithium vanadium oxide, lithium iron fluorophosphates, sodium iron phosphate, sodium iron fluorophosphates, sodium vanadium fluorophosphates, sodium vanadium chromium fluorophosphates, sodium hexacyanometallates, potassium hexacyanometallates, and lithium-containing layered compounds having hexagonal symmetry based on α-NaFeO₂ structure with a space group of R3-m.

3. The electrode of claim 1 wherein:
the active material is lithium cobalt oxide.

4. The electrode of claim 1 wherein:
at least some cobalt in the cobalt oxyhydroxide of the conductive agent has a +4 oxidation state.

5. The electrode of claim 1 wherein:
at least some cobalt in the cobalt oxyhydroxide of the conductive agent has a +3 oxidation state.

6. The electrode of claim 1 wherein:
the porous metallic substrate comprises a porous aluminum material.

7. The electrode of claim 1 wherein:
the porous metallic substrate comprises a porous nickel material.

8. The electrode of claim 1 wherein:
the substrate comprises a metal selected from aluminum, copper, silver, iron, zinc, nickel, titanium, and gold.

9. The electrode of claim 1 wherein:
the porous metallic substrate is composed of a foam.

10. The electrode of claim 1 wherein:
the porous metallic substrate is composed of a plurality of bonded fibers.

11. The electrode of claim 1 wherein:
the electrode material penetrates into the porous metallic substrate thereby providing a greater loading surface area in comparison to a flat non-porous substrate.

12. The electrode of claim 1 wherein:
the conductive electrode material contains no carbon.

13. The electrode of claim 1 wherein:
the conductive electrode material further comprises polyvinylidene fluoride as a binder.

14. The electrode of claim 1 wherein:
the electrode is a cathode.

15. The electrode of claim 1 wherein:
the conductive electrode material further includes an additive in the form of a metallic powder.

16. The electrode of claim 15 wherein:
the metallic powder is an aluminum powder.

17. An electrochemical device comprising:
an electrode according to claim 1 as a positive electrode;
a negative electrode; and
a non-aqueous electrolyte.

18. The electrochemical device of claim 17 wherein:
the negative electrode comprises a negative electrode active material selected from the group consisting of lithium metal, graphite, lithium metal oxides, hard carbon, tin/cobalt alloy, and silicon/carbon.

19. The electrochemical device of claim 17, wherein the electrochemical device is a lithium-ion battery.

20. The electrochemical device of claim 17, wherein the electrochemical device is a capacitor.

21. The electrochemical device of claim 17, wherein the electrochemical device is a sensor.

22. A method for producing an electrode, the method comprising:
applying a conductive paste to a porous metallic substrate in which the conductive paste includes an active material comprising an alkali metal compound providing an alkali metal ion for an electrochemical reaction and a conductive agent comprising cobalt hydroxide.

23. The method of claim 22 further comprising the step of:
oxidizing the cobalt hydroxide to form cobalt oxyhydroxide.

24. The method of claim 22 wherein:
at least some cobalt in the cobalt oxyhydroxide has a +3 oxidation state and at least some cobalt in the cobalt oxyhydroxide has a +4 oxidation state.
